(19) United States
(12) Patent Application Publication
(10) Pub. No.: US 2018/0148339 A1
(43) Pub. Date: May 31, 2018

(54) FABRICATION OF A ROLL OF A GRAPHITE FILM BASED ON A ROLLED POLYIMIDE FILM

(71) Applicant: TAIMIDE TECHNOLOGY INCORPORATION, Hsinchu County (TW)

(72) Inventors: Jia-Hao Wu, Hsinchu Hsien (TW); Yu-Chen Lai, Hsinchu Hsien (TW)

(21) Appl. No.: 15/372,109

(22) Filed: Dec. 7, 2016

(30) Foreign Application Priority Data
Nov. 29, 2016 (TW) 105139218

(51) Int. Cl. C01B 32/205; C08J 5/18; C08G 73/10

(52) U.S. Cl. CPC C01B 32/205; C08J 5/18; C08J 2379/08; C08G 73/1067; C08G 73/1007

(57) ABSTRACT

A process of fabricating a graphite film includes providing a roll of a polyimide film, applying a first thermal treatment so that the roll of the polyimide film is carbonized to form a roll of a carbon film, and applying a second thermal treatment so that the roll of the carbon film is converted to a roll of a graphite film. The rolled polyimide film has a thickness between 10 μm and 150 μm, and includes polyimide derived from reaction of diamine monomers with dianhydride monomers, the dianhydride monomers including pyromellitic dianhydride (PMDA), the diamine monomers including 4,4′-oxydianiline (4,4′-ODA) and phenylenediamine (PDA) with a ODA:PDA diamine molar ratio being 50:50 to 80:20.

### CROSS-REFERENCE TO RELATED APPLICATION(S)

This application claims priority to Taiwan Patent Application No. 105139218 filed on Nov. 29, 2016, the disclosure of which is incorporated herein by reference.

### FIELD OF THE DISCLOSURE

The present application relates to the fabrication of graphite films based on polyimide films.

### BACKGROUND OF THE DISCLOSURE

Thin and lightweight electronic products have become a major development trend in the increasing demand of mobile devices. As electronic components have their size reduced, more efficient heat dissipation is required, especially for components such as the chip, the backlight module and the battery. Synthetic flexible graphite films can meet the high requirements of thermal conduction (its thermal conductivity is four times better than that of copper) and heat dissipation, and offer good flexibility. Accordingly, graphite films are widely used in the manufacture of mobile devices.

A graphite film having high thermal conductivity can be fabricated by performing multiple processing steps of pyrolysis and atom rearrangement to produce pure carbon atoms. These thermal treatments generally include a carbonizing process and a graphitizing process. The carbonizing process consists in pyrolyzing non-carbon elements at a temperature between 800° C. and 1300° C. The graphitizing process applies heat at a higher temperature between 2500° C. and 3000° C. so that the carbon atoms are displaced and rearranged so as to form a layer having continuous and ordered arrangement of carbon atoms. The obtained graphite film is then subjected to a rolling treatment by which a flexible graphite film can be formed, which is suitable for use as a heat dissipation layer or electromagnetic wave shielding layer in an electronic device.

Generally, the initial polymer sheet used for fabricating the graphite film undergoes the carbonizing and graphitizing steps in a stretched and planar state, so that the formed graphite film is also in a stretched and planar state. Some other approach has attempted to use a polymer roll for fabricating a graphite film, but the rolled polymer film generally becomes brittle or breaks easily during the carbonizing process, which fails to form a desirable graphite film.

Therefore, there is a need for a process of fabricating a graphite film that can be more easily implemented, and overcome at least the aforementioned issues.

### SUMMARY

The present application provides a process of fabricating a graphite film comprising providing a roll of a polyimide film; applying a first thermal treatment so that the roll of the polyimide film is carbonized to form a roll of a carbon film; applying a second thermal treatment so that the roll of the carbon film is converted to a roll of a graphite film.

The present application also provides a polyimide film suitable for fabricating a graphite film. The polyimide film comprises a polyimide derived from reaction of diamine monomers with dianhydride monomers, the dianhydride monomers including pyromellitic dianhydride (PMDA), the diamine monomers including 4,4′-oxydianiline (4,4′-ODA) and phenylenediamine (PDA) with a ODA:PDA diamine molar ratio being 50:50 to 80:20. With the combination of the diamine and dianhydride monomers, the polyimide film has suitable mechanical properties that can avoid breaking or cracking during carbonizing and graphitizing steps. The graphite film obtained from the polyimide film has excellent mechanical properties.

### BRIEF DESCRIPTION OF THE DRAWINGS

FIG. 1 is a flowchart illustrating a process of fabricating a graphite film, according to an example embodiment of the disclosure;

FIG. 2 is a schematic view illustrating a roll of a polyimide film described in the flowchart of FIG. 1, according to an example embodiment of the disclosure; and

FIG. 3 is a schematic view illustrating a roll of a polyimide film described in the flowchart of FIG. 1, according to an example embodiment of the disclosure.

### DETAILED DESCRIPTION OF THE EMBODIMENTS

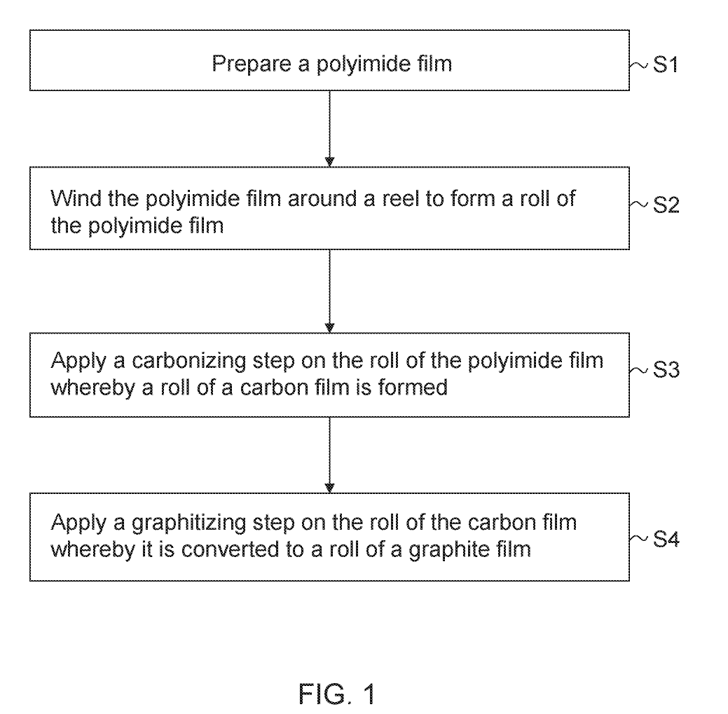

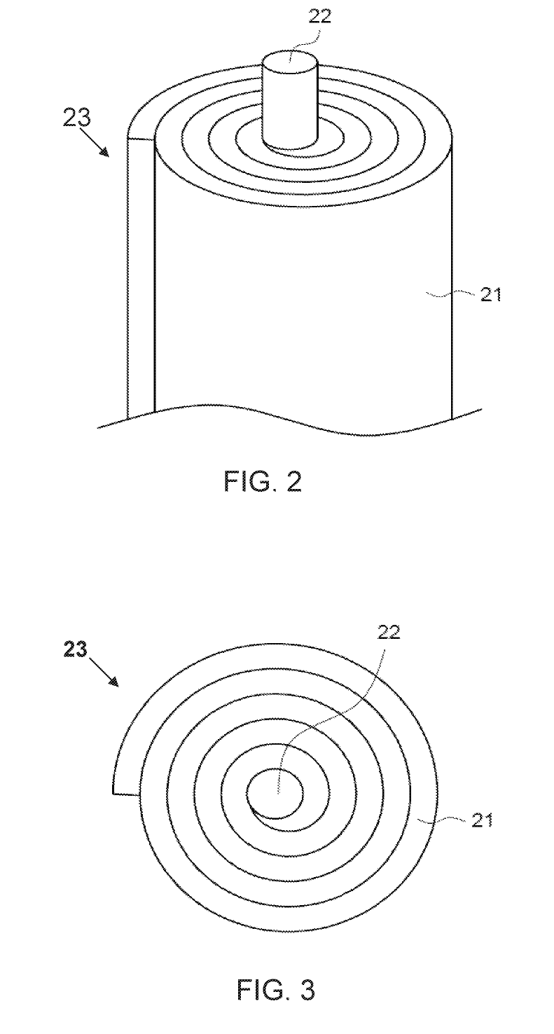

The present application describes a polyimide film suitable for use in the fabrication of a graphite film, and a process of fabricating a graphite film based on a polyimide film. The polyimide film is provided in the form of a roll that undergoes heating, whereby it is converted into an as-formed roll of a graphite film. FIG. 1 is a flowchart illustrating processing steps of fabricating a graphite film from a polyimide film, and FIGS. 2-3 are schematic views illustrating a roll of polyimide film described in the flowchart of FIG. 1

In initial step S1, a polyimide film is provided. The polyimide film has a Young's modulus between about 330 kgf/mm² and about 480 kgf/mm². These characteristics of the polyimide film may allow to obtain a graphite film that is not brittle and have desirable properties. The polyimide film may include polyimide derived from reaction of diamine monomers with dianhydride monomers. The dianhydride monomers include pyromellitic dianhydride (PMDA), and the diamine monomers include 4,4′-oxydianiline (4,4′-ODA) and phenylenediamine (PDA) with a diamine molar ratio of ODA:PDA being 50:50 to 80:20.

In step S2, the polyimide film 21 is wound around a reel 22 to form a roll 23, as shown in FIG. 2 and FIG. 3.

In step S3, the roll of the polyimide film 23 undergoes a carbonizing step for forming a roll of a carbon film. The thermal treatment of the carbonizing step may be performed at a temperature between about 800° C. and about 1300° C. The carbonizing step may be performed under a reduced pressure or a nitrogen atmosphere.

The roll of the carbon film in step S4 then undergoes a graphitizing step, whereby it is converted to an as-formed roll of a graphite film. The thermal treatment of the graphitizing step may be performed at a temperature between about 2500° C. and about 3000° C. Moreover, the graphitizing step may be performed under a reduced pressure or an atmosphere of inert gas such as argon, helium and the like. An as-formed roll of a graphite film having desirable mechanical properties can be thereby obtained.

More detailed examples of fabricating polyimide films and graphite films are described hereinafter.

### EXAMPLES AND COMPARATIVE EXAMPLES

### Example 1

Preparation of a Polyamic Acid Solution

4,4′-ODA and PDA with a molar ratio of 80:20 are dissolved in DMAC solvent. PMDA then is added to react and form a polyamic acid solution (containing 20% of solid content). The molar ratio of diamine monomers and dianhydride monomers is 1:1.

Preparation of a Polyimide Film

A layer of the polyamic acid solution is coated on a steel belt, and is heated at a temperature of 80° C. for 30 minutes to remove most solvent. The layer of the polyamic acid solution is then heated at a temperature between 170° C. and 370° C. for 4 hours, and then subjected to a biaxial orientation to obtain a polyimide film. Three polyimide films of different thicknesses are fabricated, i.e., respectively having 38 μm, 50 μm and 75 μm as thickness.

Each polyimide film has a length of 50 meters, and is coiled on a graphite reel to form a polyimide film roll.

Preparation of a Graphite Film

Each roll of the polyimide film is carbonized at a temperature between 800° C. and 1300° C. to form a roll of a carbon film. Then the roll of the carbon film is graphitized at a temperature of about 2800° C. to form a foamed graphite film. The foamed graphite film is subjected to a rolling and pressing treatment to obtain a predetermined thickness. Three rolls of a graphite film respectively having 17 μm, 25 μm and 40 μm can be thereby formed.

### Examples 2-7 and Comparative Example 1

Graphite films are fabricated like in Example 1, except that the molar ratio of ODA/PDA and the film thickness are changed as indicated in Table 1.

Tests of Film Properties

Young's Modulus

The Young's modulus of a polyimide film is measured by using a universal testing machine sold under the designation Tinius Olsen H10KS based on the ASTM D 822 method.

TABLE 1

| | | | Thickness | | | Thickness | |
|---|---|---|---|---|---|---|---|
| | | Young's | of poly- | Appearance* | | of final | Thermal |
| | Molar ratio | modulus | imide film | carbon | graphite | graphite film | diffusivity |
| | of ODA/PDA | (kgf/mm²) | (μm) | film | film | (μm) | coefficient |
| Example 1 | 80/20 | 330 | 38 | G | P | 17 | 8.3 |
| | | | 50 | E | G | 25 | 8.2 |
| | | | 75 | E | G | 40 | 8.0 |
| Example 2 | 75/25 | 400 | 38 | E | E | 17 | 8.2 |
| | | | 50 | E | E | 25 | 8.1 |
| | | | 75 | E | G | 40 | 7.9 |
| Example 3 | 70/30 | 420 | 25 | E | G | 10 | 8.2 |
| | | | 38 | E | E | 17 | 8.1 |
| | | | 50 | E | E | 25 | 8.0 |
| | | | 75 | E | E | 40 | 7.9 |
| Example 4 | 65/35 | 450 | 25 | E | E | 10 | 8.1 |
| | | | 38 | E | E | 17 | 8.0 |
| | | | 50 | E | G | 25 | 7.9 |
| Example 5 | 60/40 | 470 | 25 | E | E | 10 | 8.1 |
| | | | 38 | E | E | 17 | 8.0 |
| Example 6 | 50/50 | 480 | 25 | E | E | 10 | 8.0 |
| | | | 38 | E | G | 17 | 7.9 |
| Example 7 | 40/60 | 490 | 25 | E | G | 10 | 7.9 |
| | | | 38 | E | G | 17 | 7.8 |
| Comparative | 100/0 | 310 | 38 | G | P | 17 | 8.5 |
| Example 1 | | | 50 | G | P | 25 | 8.4 |
| | | | 75 | P | P | 40 | 8.2 |

*Appearance: E (excellent): no crack; G (good): less than 5 cracks; P (poor): 5 cracks or more or broken film.

Referring to Table 1, it can be observed that a higher molar ratio of PDA is required to prepare a thinner graphite film with good appearance. Moreover, by comparing among graphite films of different thicknesses that are obtained from a same polyimide film, it appears that the thinner graphite film has a higher thermal diffusivity coefficient.

In some examples of implementation, a roll of a graphite film can be fabricated from a roll of a polyimide film having a thickness of 38 μm that is formed with a ODA: PDA diamine molar ratio ranging from 60:40 to 75:25. The rolled graphite film has a thickness of 17 μm, and has a desirable appearance.

Advantages of the process described herein include the ability to fabricate an as-formed roll of a graphite film, which requires no manual laminating step and allows continuous production and significant reduction in the fabrication cost.

Realizations of the fabrication process and films have been described in the context of particular embodiments. These embodiments are meant to be illustrative and not limiting. Many variations, modifications, additions, and improvements are possible. These and other variations, modifications, additions, and improvements may fall within the scope of the disclosure as defined in the claims that follow.

What is claimed is:

1. A process of fabricating a graphite film, comprising:
providing a roll of a polyimide film, the polyimide film being formed from reaction of diamine monomers with dianhydride monomers, the dianhydride monomer including pyromellitic dianhydride (PMDA), the diamine monomers including 4,4′-oxydianiline (4,4′-ODA) and phenylenediamine (PDA) with a molar ratio of ODA:PDA being 50:50 to 80:20, and the polyimide film having a thickness between about 10 μm and about 150 μm;
applying a first thermal treatment so that the roll of the polyimide film is carbonized to form a roll of a carbon film; and
applying a second thermal treatment so that the roll of the carbon film is converted to a roll of a graphite film.

2. The process according to claim 1, wherein the polyimide film has a Young's modulus between about 330 kgf/mm² and about 480 kgf/mm².

3. The process according to claim 1, wherein the molar ratio of ODA:PDA is 70:30 to 50:50, and the polyimide film has a thickness between about 10 μm and about 25 μm.

4. The process according to claim 1, wherein the molar ratio of ODA:PDA is 75:25 to 60:40, and the polyimide film has a thickness between about 25 μm and about 38 μm.

5. The process according to claim 1, wherein the molar ratio of ODA:PDA is 80:20 to 65:35, and the polyimide film has a thickness between about 38 μm and about 75 μm.

6. The process according to claim 1, wherein the molar ratio of ODA:PDA is 80:20 to 70:30, and the polyimide film has a thickness between about 75 μm and about 125 μm.

7. The process according to claim 1, wherein the first thermal treatment is performed at a temperature between about 800° C. and about 1300° C.

8. The process according to claim 1, wherein the second thermal treatment is performed at a temperature between about 2500° C. and about 3000° C.

9. A roll of a polyimide film suitable for use in the fabrication of a roll of a graphite film, the polyimide film comprising a polyimide derived from reaction of diamine monomers with dianhydride monomers, the dianhydride monomer comprises pyromellitic dianhydride (PMDA), the diamine monomer comprises 4,4′-oxydianiline (4,4′-ODA) and phenylenediamine (PDA) with a molar ratio of ODA:PDA being 50:50 to 80:20.

10. The roll of a polyimide film according to claim 9, wherein the polyimide film has a Young's modulus between about 330 kgf/mm² and about 480 kgf/mm².

11. The roll of a polyimide film according to claim 9, wherein the diamine molar ratio of ODA:PDA is 70:30 to 50:50, and the polyimide film has a thickness between about 10 μm and about 25 μm.

12. The roll of a polyimide film of claim 9, wherein the diamine molar ratio of ODA:PDA is 75:25 to 60:40, so that a polyimide film having a thickness of 25 μm to 38 μm is obtained.

13. The roll of a polyimide film of claim 9, wherein the diamine molar ratio of ODA:PDA is 80:20 to 65:35, so that a polyimide film having a thickness of 38 μm to 75 μm is obtained.

14. The roll of a polyimide film of claim 9, wherein the diamine molar ratio of ODA:PDA is 80:20 to 70:30, so that a polyimide film having a thickness of 75 μm to 125 μm is obtained.
